(19) United States
(12) Patent Application Publication
(10) Pub. No.: US 2015/0266414 A1
(43) Pub. Date: Sep. 24, 2015

(54) Automatic Braking Indicator

(71) Applicants: Christopher Lee Bailey, Louisville, KY (US); Jason Harrington, Louisville, KY (US); Nathan Ross Armentrout, New Albany, IN (US)

(72) Inventors: Christopher Lee Bailey, Louisville, KY (US); Jason Harrington, Louisville, KY (US); Nathan Ross Armentrout, New Albany, IN (US)

(73) Assignee: TOPHERTRONICS, LLC, Louisville, KY (US)

(21) Appl. No.: 14/659,627

(22) Filed: Mar. 17, 2015

Related U.S. Application Data
(60) Provisional application No. 61/969,816, filed on Mar. 24, 2014.

(51) Int. Cl. B60Q 1/44

(52) U.S. Cl. CPC B60Q 1/44

(57) ABSTRACT

An automatic braking indicator according to one example embodiment includes a sensor for detecting a plurality of accelerations of a vehicle, a processor in communication with the sensor and a brake light switch in communication with the processor. The processor receives signals from the sensor corresponding to the plurality of accelerations of the vehicle, filters the signals from the sensor to remove signals from vehicle vibrations, compares a first signal corresponding to a first acceleration of the vehicle to a first set amount and sends a brake signal to the brake light switch to turn a brake light on if the first acceleration of the vehicle is less than the first set amount.

### CROSS-REFERENCE TO RELATED APPLICATIONS

This application claims priority to U.S. Provisional Application No. 61/969,816, entitled “Automatic Braking Indicator” and filed on Mar. 24, 2014, which is incorporated by reference herein in its entirety.

### BACKGROUND

1. Field of the Disclosure

The present invention relates generally to braking indicators, and more specifically to automatic braking indicators.

2. Description of the Related Art

Vehicles with manual transmissions are typically able to decelerate rapidly without the use of their brakes through the use of engine braking and downshifting. When slowing down through the use of engine braking or downshifting, however, a vehicle's brake lights usually do not come on, causing a serious hazard to the vehicle's driver and to following vehicles. Also, when regenerative braking occurs in vehicles with the ability to regeneratively brake, the vehicles often do not light their vehicle brake lights as the standard brakes are not being used. Without the brake lights engaged, it is difficult for following vehicles to accurately judge when vehicles are slowing.

Currently, speed sensor systems are used to determine when the wheels of a vehicle are turning slower and to engage a brake light. Such systems typically include speed sensors placed on the wheels of a vehicle. However, speed sensor systems are often costly and difficult to install. Mechanical switch sensors are also currently used to detect deceleration in a vehicle and to provide a rear warning. Mechanical switches often include metal contacts and a rolling ball or spring to complete a circuit when deceleration forces are applied to them. However, such switches tend to provide many false positives of deceleration.

Accordingly, it will be appreciated that automatic braking indicators that efficiently and effectively indicate deceleration and prevent false positive indications of deceleration are desired.

### SUMMARY

An automatic braking indicator according to one example embodiment includes a sensor for detecting a plurality of accelerations of a vehicle, a processor in communication with the sensor and a brake light switch in communication with the processor. The processor receives signals from the sensor corresponding to the plurality of accelerations of the vehicle, filters the signals from the sensor to remove signals from vehicle vibrations, compares a first signal corresponding to a first acceleration of the vehicle to a first set amount and sends a brake signal to the brake light switch to turn a brake light on if the first acceleration of the vehicle is less than the first set amount.

An automatic braking indicator according to another example embodiment includes a sensor for detecting a plurality of accelerations of a vehicle, a processor in communication with the sensor and a brake light switch in communication with the processor. The processor receives signals from the sensor corresponding to the plurality of accelerations of the vehicle, filters the signals from the sensor to remove signals from vehicle vibrations, compares a first signal corresponding to a first acceleration of the vehicle to a first set amount and sends a flash signal to flash a brake light on and off if the first acceleration of the vehicle is less than the first set amount.

An automatic braking indicator system according to one example embodiment includes a power source, an automatic braking indicator connected to the power source, a brake light switch in communication with the automatic braking indicator and a brake light in communication with the brake light switch. The automatic braking indicator has a sensor for detecting a plurality of accelerations of a vehicle and a processor in communication with the sensor and with the brake light switch. The processor receives signals from the sensor corresponding to the plurality of accelerations of the vehicle, filters the signals from the sensor to remove signals from vehicle vibrations, compares a first signal corresponding to a first acceleration of the vehicle to a first set amount and sends a brake signal to the brake light switch to turn the brake light on if the first acceleration of the vehicle is less than the first set amount.

### BRIEF DESCRIPTION OF THE DRAWINGS

The above-mentioned and other features and advantages of the various embodiments, and the manner of attaining them, will become more apparent and will be better understood by reference to the accompanying drawings.

FIG. 1 is a schematic view of an automatic braking indicator system according to multiple embodiments and alternatives; and

FIG. 2 is a schematic view of a circuit of the automatic braking indicator system according to multiple embodiments and alternatives.

### DETAILED DESCRIPTION

The following description and drawings illustrate embodiments sufficiently to enable those skilled in the art to practice the present invention. It is to be understood that the disclosure is not limited to the details of construction and the arrangement of components set forth in the following description or illustrated in the drawings. The invention is capable of other embodiments and of being practiced or of being carried out in various ways. For example, other embodiments may incorporate structural, chronological, electrical, electronic, process and other changes. Examples merely typify possible variations. Individual components and functions are optional unless explicitly required, and the sequence of operations may vary. Portions and features of some embodiments may be included in or substituted for those of others. The following description is, therefore, not to be taken in a limited sense.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings and mountings. In addition, the terms “connected” and “coupled” and variations thereof are not restricted to physical or mechanical connections or couplings.

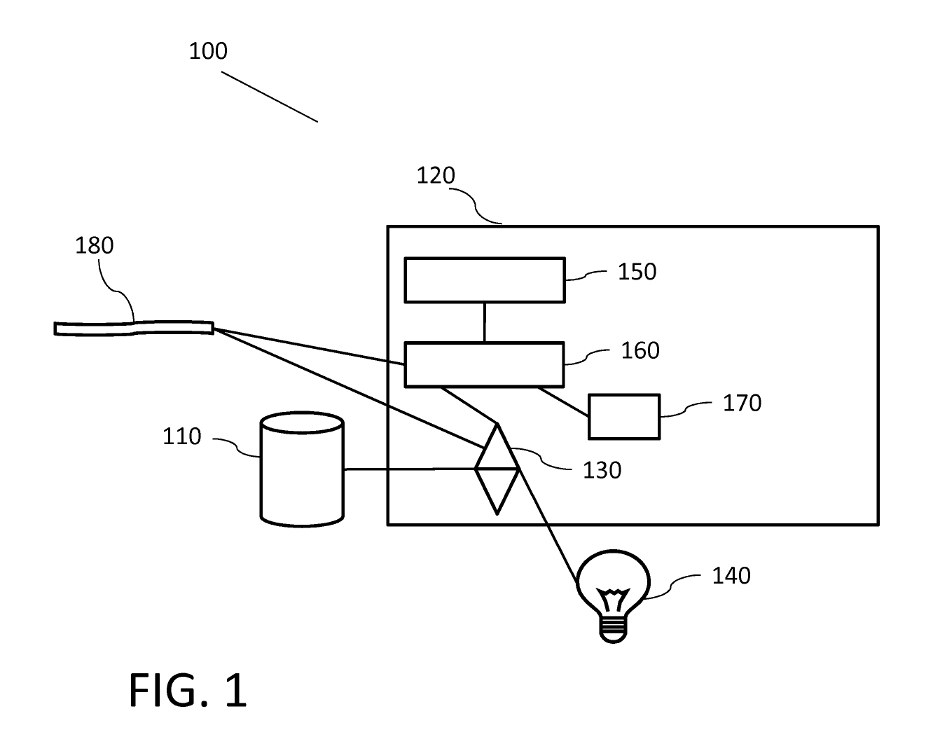

Turning now to the drawings, and more particularly to FIG. 1, an example embodiment of an automatic braking indicator system 100 is illustrated. The automatic braking indicator system 100 includes a power source 110, an automatic braking indicator 120 connected to the power source 110, a brake light switch 130 in communication with the automatic braking indicator 120 and a brake light 140 in communication with the brake light switch 130.

In some embodiments, the automatic braking indicator 120 of the automatic braking indicator system 100 may be integrally formed with a vehicle. In other embodiments, the automatic braking indicator 120 may be mounted on the vehicle. The vehicle may be any of a variety of moving vehicles, such as a motorcycle, bicycle, trailer, bus, snow mobile, go cart or four-wheeler, for example. In some embodiments, the vehicle may be a vehicle with a manual transmission, such as a motorcycle, automobile, tractor or fork lift, for example. In some embodiments, the vehicle may be a vehicle with regenerative braking, such as an electric or hybrid vehicle, for example.

In some embodiments, the power source 110 of the automatic braking indicator system 100 is a 12 V power source. In certain embodiments, the power source 110 is part of a switched circuit, such as a running vehicle light circuit or a license plate light circuit, for example. In certain embodiments, the power source 110 is a battery.

In multiple embodiments, the automatic braking indicator 120 has a sensor 150 for detecting a plurality of accelerations or velocities of the vehicle and a processor 160 in communication with the sensor 150 and in communication with the brake light switch 130. The sensor 150 may be any of a variety of mechanisms that can detect accelerations or velocities of a vehicle. In some embodiments, for example, the sensor 150 is an accelerometer. In certain embodiments, the sensor 150 is a three axis accelerometer. In other embodiments, the sensor 150 may include a speedometer, tachometer, rotation sensor, radar sensor, gyroscope, optic sensor or global positioning system (GPS) sensor. In other embodiments, the sensor 150 may include or be in communication with a vehicle electrical control unit (ECU).

Communication between the sensor 150 and the processor 160 may be established via a wired or wireless connection as is known in the art. The processor 160 may include a single processor unit or multiple processor units in communication with each other. Each processor unit may include, or be communicatively coupled to, memory having computer executable storage instructions. The processor may execute the computer executable storage instructions, causing the processor unit(s) to perform their function.

In some embodiments, the brake light switch 130 of the automatic braking indicator system 100 may be integrally formed with the automatic braking indicator 120. In some embodiments, the brake light switch 130 may be distinct from the automatic braking indicator 120. In some embodiments, the brake light switch 130 of the automatic braking indicator system 100 is a vehicle brake light switch, such as the switch of an existing brake light mounted on a vehicle, for example. In other embodiments, the brake light switch 130 may be an auxiliary brake light switch. In still other embodiments, the brake light switch 130 may include one or more vehicle brake light switches and one or more auxiliary brake light switches. The brake light switch 130 may be any of a variety of mechanisms that can operate as a logic switch. In some embodiments, for example, the brake light switch 130 is a field effect transistor (FET). Communication between the processor 160 and the brake light switch 130 may be established via a wired or wireless connection as is known in the art.

In some embodiments, the brake light 140 of the automatic braking indicator system 100 is a vehicle brake light, such as an existing brake light mounted on a vehicle, for example. In other embodiments, the brake light 140 may be an auxiliary brake light. In still other embodiments, the brake light 140 may include one or more vehicle brake lights and one or more auxiliary brake lights. The auxiliary brake light may be any of a variety of light mechanisms, such as a light emitting diode (LED) strip, a license plate light, a helmet light, a vest light or a jacket light, for example. Communication between the brake light switch 130 and the brake light 140 may be established via a wired or wireless connection as is known in the art. In some embodiments, the brake light switch 130 may communicate with the brake light 140 via an output wire connected to a splice in an existing vehicle brake signal wire 180 to send signals to an existing vehicle brake light. In such embodiments, the brake light switch 130 connection to the brake light 140 prevents the automatic braking indicator 120 from impeding or disrupting the existing vehicle brake signal. In some embodiments, the brake light switch 130 may communicate with the brake light 140 via processor input and brake light switch output wires connected to a cut in the existing vehicle brake signal wire 180 to send signals to an existing vehicle brake light.

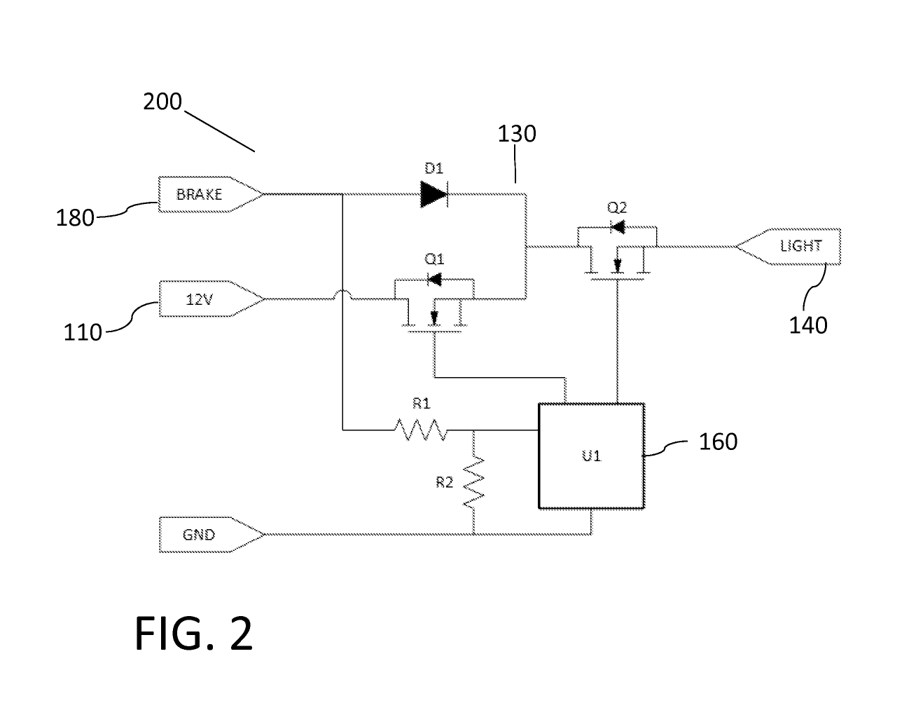

In some embodiments, the automatic braking indicator 120 is able to power the brake light 140 from the power source 110. In some embodiments, the automatic braking indicator 120 is able to power the brake light 140 from an existing vehicle brake signal wire 180. In some embodiments, the automatic braking indicator is able to power the brake light 140 from the power source 110 and the existing vehicle brake signal wire 180. As shown in FIG. 2, in certain embodiments, the automatic braking indicator includes the circuit 200 to power the brake light 140 from the power source 110 and the existing vehicle brake signal wire 180. In certain embodiments, the circuit 200 also includes the processor 160, resistors R1 and R2 and the brake light switch 130. In certain embodiments, the brake light switch 130 includes an auxiliary power switch Q1, a vehicle brake light switch Q2 and a diode D1. In certain embodiments, the circuit 200 prevents engine trouble codes caused by adding the automatic braking indicator to the vehicle.

Returning to FIG. 1, in some embodiments, the automatic braking indicator 120 also includes a switch 170 in communication with the processor 160 for altering functions of the automatic braking indicator 120. In certain embodiments, the switch 170 may be a push button switch, a selector switch or a magnetic switch. Communication between the switch 170 and the processor 160 may be established via a wired or wireless connection as is known in the art.

In some embodiments, the automatic braking indicator system 100 also includes a mobile device in communication with the processor 160. In certain embodiments, the mobile device may be a laptop computer, tablet computer, remote control or handheld device, such as a smartphone, for example. Communication between the mobile device and the processor 160 may be established via a wired or wireless connection as is known in the art.

In some embodiments, the automatic braking indicator system 100 also includes a proximity sensor in communication with the processor 160. The proximity sensor may be any of a variety of mechanisms that can detect the presence of other vehicles approaching the vehicle with the automatic braking indicator system 100. In some embodiments, for example, the proximity sensor may be a light dependent resistor (LDR) sensor, radio detection and ranging (RADAR) sensor, ultrasonic sensor, infrared sensor or optic sensor. Communication between the proximity sensor and the processor 160 may be established via a wired or wireless connection as is known in the art.

In use, in multiple embodiments, the sensor 150 of the automatic braking indicator 120 detects a plurality of accelerations of the vehicle and the processor 160 receives signals from the sensor 150 corresponding to the plurality of accelerations of the vehicle. The processor 160 then filters the signals from the sensor 150 to remove signals from vehicle vibrations, compares a first signal corresponding to a first acceleration of the vehicle to a first set amount and sends a brake signal to the brake light switch 130 to turn the brake light 140 on if the first acceleration of the vehicle is less than the first set amount. Thus, the automatic braking indicator 120 detects accelerations of the vehicle and turns on the brake light 140 when it detects deceleration of the vehicle, even if a user is not using the vehicle brakes. In multiple embodiments, the automatic braking indicator 120 also sends a brake signal to turn the brake light 140 on if a user is using the vehicle brakes.

In some embodiments, the processor 160 also sends an off signal to turn the brake light 140 off if deceleration of the vehicle is no longer detected and a user is not using the vehicle brakes. In certain embodiments, the processor 160 compares a second signal corresponding to a second acceleration of the vehicle to a second set amount and sends an off signal to the brake light switch 130 to turn the brake light 140 off if the second acceleration of the vehicle is at least the second set amount.

As noted above, the processor 160 sends the brake signal to the brake light switch 130 to turn the brake light 140 on if the first acceleration of the vehicle is less than the first set amount. Further, in some embodiments, the processor 160 sends the off signal to the brake light switch 130 to turn the brake light 140 off if the second acceleration of the vehicle is at least the second set amount. In some embodiments, the first set amount is about −0.1 g or about −0.980665 m/s². In some embodiments, the second set amount is about 0.1 g or 0.980665 m/s². In some embodiments, the set amounts can be adjusted. In certain embodiments, tilting or turning the automatic braking indicator 120 adjusts the set amounts.

In some embodiments, the processor 160 also sends an auxiliary signal to an auxiliary brake light switch to turn an auxiliary brake light on if the first acceleration of the vehicle is less than the first set amount or if a user is using the vehicle brakes. The auxiliary signal may be sent via wired or wireless connection as is known in the art. In some embodiments, the processor 160 also sends an auxiliary off signal to the auxiliary brake light switch to turn the auxiliary brake light off if the second acceleration of the vehicle is at least the second set amount and if a user is not using the vehicle brakes. The auxiliary off signal also may be sent via wired or wireless connection as is known in the art.

In some embodiments, the brake light 140 flashes when deceleration of the vehicle is detected. In certain embodiments, the processor 160 sends a flash signal to flash the brake light 140 on and off if the first acceleration of the vehicle is less than the first set amount. In some embodiments, the brake light 140 pulses when deceleration of the vehicle is detected. In certain embodiments, the processor 160 sends a pulse signal to pulse the brake light 140 if the first acceleration of the vehicle is less than the first set amount.

In certain embodiments, the brake light 140 flashes or pulses for a set period of time when deceleration is detected and then remains on if deceleration of the vehicle is still detected or if a user is using the vehicle brakes. For example, the brake light 140 may flash or pulse for two seconds when deceleration is detected and then remain on if deceleration of the vehicle is still detected or if a user is using the vehicle brakes. In certain embodiments, the brake light 140 flashes or pulses for a set period of time when deceleration is detected and then turns off if deceleration of the vehicle is no longer detected and a user is not using the vehicle brakes. For example, the brake light 140 may flash or pulse for two seconds when deceleration is detected and then turn off if deceleration of the vehicle is no longer detected and a user is not using the vehicle brakes.

In some embodiments, the processor 160 sends a signal to indicate heavy deceleration of the vehicle. In certain embodiments, the processor 160 sends a flash signal to flash the brake light 140 on and off if the first acceleration of the vehicle is less than a heavy braking set amount. In certain embodiments, the processor 160 sends a pulse signal to pulse the brake light 140 if the first acceleration of the vehicle is less than a heavy braking amount.

Referring to FIG. 2, in some embodiments, when a user is not using the vehicle brakes and deceleration of the vehicle is not detected, the vehicle brake light switch Q2 is turned on and the auxiliary power switch Q1 is turned off. In some embodiments, when a user is using the vehicle brakes, the auxiliary power switch Q1 is turned off and the vehicle brake light switch Q2 is turned on, pulsed or flashed. In some embodiments, when the automatic braking indicator detects deceleration of the vehicle, the auxiliary power switch Q1 is turned on and the vehicle brake light switch Q2 is turned on, pulsed or flashed. In certain embodiments, the vehicle brake light switch Q2 and the auxiliary power switch Q1 are biased such that if the automatic braking indicator does not operate properly, the vehicle brake light switch Q2 is turned on and the auxiliary power switch Q1 is turned off to prevent the automatic braking indicator from impeding or disrupting the existing vehicle brake signal.

Returning to FIG. 1, in some embodiments, the switch 170 sends an input signal to the processor 160 to alter the function of the automatic braking indicator 120. In certain embodiments, the switch 170 may send a flash on signal to the processor 160 to flash the brake light 140. In certain embodiments, the switch 170 may send a flash off signal to the processor 160 to stop flashing the brake light 140. In certain embodiments, the switch 170 may send a flash pattern signal to the processor 160 to alter the flash pattern of the brake light 140. For example, the flash pattern signal may direct the processor 160 to increase or decrease the frequency of brake light flashing. In certain embodiments, the switch 170 may send a pulse on signal to the processor 160 to pulse the brake light 140. In certain embodiments, the switch 170 may send a pulse off signal to the processor 160 to stop pulsing the brake light 140. In certain embodiments, the switch 170 may send a pulse pattern signal to the processor 160 to alter the pulse pattern of the brake light 140. For example, the pulse pattern signal may direct the processor 160 to increase or decrease the frequency of brake light pulsing. In certain embodiments, the switch 170 may send a sensitivity signal to the processor 160 to alter the sensitivity of the automatic braking indicator 120. For example, the sensitivity signal may direct the processor 160 to increase or decrease the first, second or heavy braking set amounts.

In some embodiments, the mobile device sends an input signal to the processor 160 to alter the function of the automatic braking indicator 120. In certain embodiments, the mobile device may send a flash on signal to the processor 160 to flash the brake light 140. In certain embodiments, the mobile device may send a flash off signal to the processor 160 to stop flashing the brake light 140. In certain embodiments, the mobile device may send a flash pattern signal to the processor 160 to alter the flash pattern of the brake light 140. For example, the flash pattern signal may direct the processor 160 to increase or decrease the frequency of brake light flashing. In certain embodiments, the mobile device may send a pulse on signal to the processor 160 to pulse the brake light 140. In certain embodiments, the mobile device may send a pulse off signal to the processor 160 to stop pulsing the brake light 140. In certain embodiments, the mobile device may send a pulse pattern signal to the processor 160 to alter the pulse pattern of the brake light 140. For example, the pulse pattern signal may direct the processor 160 to increase or decrease the frequency of brake light pulsing. In certain embodiments, the mobile device may send a sensitivity signal to the processor 160 to alter the sensitivity of the automatic braking indicator 120. For example, the sensitivity signal may direct the processor 160 to increase or decrease the first, second or heavy braking set amounts.

In some embodiments, the processor 160 sends an output signal to the mobile device. In certain embodiments, the processor 160 may send the mobile device readings from the sensor 150, for example. The mobile device may use such readings or other information from the processor 160 to provide useful information to a user, such as acceleration, performance or crash status, for example. If a crash is detected by the automatic braking indicator 120, information sent to the mobile device may be used for emergency medical services (EMS) crash notification. Information sent to the mobile device also may be used for other data recording and analyzing purposes.

In some embodiments, the processor 160 filters the signals from the sensor to remove signals from vehicle vibrations and other mechanical and electrical noise by using a low-pass filter. Such vehicle vibrations may be caused by road noise, potholes or rough road conditions, for example. In certain embodiments, the low-pass filter removes signals with a frequency above a set frequency. In filtering and removing signals, the processor 160 reduces false positive indications of deceleration.

In some embodiments, the processor 160 of the automatic braking indicator 120 levels the automatic braking indicator 120. In such embodiments, the automatic braking indicator 120 may be mounted in a variety of orientations or operate at an angle from a steep hill, for example. In certain embodiments, the processor 160 levels the automatic braking indicator 120 by assigning a new first and second set amount used for detecting vehicle acceleration and deceleration. The new first and second set amounts are set when the magnitude of each of a plurality of accelerations over a previous amount of time, such as one second, for example, is about equal to the acceleration caused by gravity within a set error tolerance. In such embodiments, the average of the plurality of accelerations over the previous amount of time is used to adjust the first and second set amounts.

In some embodiments, if the proximity sensor detects the presence of other vehicles approaching the vehicle, it sends a proximity signal to the processor 160. In certain embodiments, if the proximity sensor detects a rate of approach of another vehicle that is greater than a set approach rate, the processor 160 sends a brake signal to the brake light switch 130 to turn the brake light 140 on. In certain embodiments, if the proximity sensor detects a rate of approach of another vehicle that is greater than a set approach rate, the processor 160 sends an auxiliary signal to turn an auxiliary light on. Thus, other vehicles approaching the vehicle may receive a warning when they become close to the vehicle.

It will be appreciated that the automatic braking indicator system 100 efficiently and effectively indicates deceleration and prevents false positive indications of deceleration. Further, the system 100 allows advanced warning time to following drivers, improves braking reaction times and reduces the risk of vehicle collisions.

The foregoing description of several embodiments has been presented for purposes of illustration. It is not intended to be exhaustive or to limit the application to the precise forms disclosed, and obviously many modifications and variations are possible in light of the above teaching. It is understood that the invention may be practiced in ways other than as specifically set forth herein without departing from the scope of the invention. It is intended that the scope of the application be defined by the claims appended hereto.

What is claimed is:

1. An automatic braking indicator, comprising:
a sensor for detecting a plurality of accelerations of a vehicle;
a processor in communication with the sensor; and
a brake light switch in communication with the processor,
wherein the processor receives signals from the sensor corresponding to the plurality of accelerations of the vehicle, filters the signals from the sensor to remove signals from vehicle vibrations, compares a first signal corresponding to a first acceleration of the vehicle to a first set amount and sends a brake signal to the brake light switch to turn a brake light on if the first acceleration of the vehicle is less than the first set amount.

2. The automatic braking indicator of claim 1, wherein the sensor is an accelerometer.

3. The automatic braking indicator of claim 1, wherein the first set amount can be adjusted.

4. The automatic braking indicator of claim 1, wherein the brake light is the vehicle brake light.

5. The automatic braking indicator of claim 4, wherein the processor further sends an auxiliary signal to an auxiliary brake light switch to turn an auxiliary brake light on if the first acceleration of the vehicle is less than the first set amount.

6. The automatic braking indicator of claim 1, wherein the brake light is an auxiliary brake light.

7. The automatic braking indicator of claim 1, wherein the processor further sends a pulse signal to pulse the brake light if the first acceleration of the vehicle is less than the first set amount.

8. The automatic braking indicator of claim 1, wherein the processor further sends a flash signal to flash the brake light on and off if the first acceleration of the vehicle is less than a heavy braking set amount.

9. The automatic braking indicator of claim 1, wherein a mobile device sends a pulse on signal to the processor to pulse the brake light.

10. The automatic braking indicator of claim 1, wherein a mobile device sends a flash pattern signal to the processor to alter a flash pattern of the brake light.

11. The automatic braking indicator of claim 1, wherein a mobile device sends a sensitivity signal to the processor to adjust the first set amount.

12. An automatic braking indicator, comprising:
a sensor for detecting a plurality of accelerations of a vehicle;
a processor in communication with the sensor; and
a brake light switch in communication with the processor,
wherein the processor receives signals from the sensor corresponding to the plurality of accelerations of the vehicle, filters the signals from the sensor to remove signals from vehicle vibrations, compares a first signal corresponding to a first acceleration of the vehicle to a first set amount and sends a flash signal to flash a brake light on and off if the first acceleration of the vehicle is less than the first set amount.

13. The automatic braking indicator of claim 12, wherein the sensor is an accelerometer.

14. The automatic braking indicator of claim 12, wherein the first set amount can be adjusted.

15. The automatic braking indicator of claim 12, wherein the brake light is the vehicle brake light.

16. The automatic braking indicator of claim 12, wherein the brake light is an auxiliary brake light.

17. The automatic braking indicator of claim 12, wherein a mobile device sends a sensitivity signal to the processor to adjust the first set amount.

18. An automatic braking indicator system, comprising:
a power source;
an automatic braking indicator connected to the power source;
a brake light switch in communication with the automatic braking indicator; and
a brake light in communication with the brake light switch,
wherein the automatic braking indicator has a sensor for detecting a plurality of accelerations of a vehicle and a processor in communication with the sensor and with the brake light switch and wherein the processor receives signals from the sensor corresponding to the plurality of accelerations of the vehicle, filters the signals from the sensor to remove signals from vehicle vibrations, compares a first signal corresponding to a first acceleration of the vehicle to a first set amount and sends a brake signal to the brake light switch to turn the brake light on if the first acceleration of the vehicle is less than the first set amount.

19. The automatic braking indicator system of claim 18, wherein the sensor is an accelerometer.

20. The automatic braking indicator system of claim 18, wherein the processor further sends a flash signal to flash the brake light on and off if the first acceleration of the vehicle is less than the first set amount.
